(19) United States
(12) Patent Application Publication
(10) Pub. No.: US 2017/0068558 A1
(43) Pub. Date: Mar. 9, 2017

(54) VIRTUAL MACHINE MANAGEMENT SYSTEM AND METHOD THEREFOR

(71) Applicant: Hitachi, Ltd., Tokyo (JP)

(72) Inventor: Yosuke TAKAIZUMI, Tokyo (JP)

(21) Appl. No.: 15/122,802

(22) PCT Filed: Jun. 12, 2014
(86) PCT No.: PCT/JP2014/065645

§ 371 Date: Aug. 31, 2016

(51) Int. Cl. G06F 9/455; H04L 12/26; G06F 9/50

(52) U.S. Cl. CPC G06F 9/45558; G06F 9/5077; H04L 43/10; G06F 9/5027; G06F 2009/45595

(57) ABSTRACT

In the present invention, a virtual machine (VM) management system comprises: a VM operating status obtaining unit that obtains the usage status of resources according to a VM; a VM communication status obtaining unit that obtains the communication status between the VM and another VM; and a sprawl handling unit that deletes the VM and recovers resources allocated to the VM if the operating status and communication status of the VM do not satisfy prescribed standards. The usage status of resources to be obtained at least includes the CPU usage rate.

### TECHNICAL FIELD

The present invention relates to a VM (virtual machine) management system and a method therefore.

### BACKGROUND ART

VM (virtual machine) technologies, which have advantages to allow parallel executions based on different OSs (operating systems) and simultaneous usage performed by plural users, have been widely used. However, that causes a sprawl phenomenon in which, as the number of virtual machines (VMs) to which computer resources are allocated increases, computer resources are not effectively used, and particularly as the number of computer resources, which are not effectively used by VMs that have already finished their activities, increases, computer resources to be allocated to new VMs becomes run short.

Patent Literature 1 discloses a technology in which it is judged whether there is the abnormal status of a VM or an application (AP) that runs on the VM (a status in which resources are used less frequently than a resource usage threshold by the VM or the AP) on the basis of the observation results of the usage statuses of resources used by the VM and the AP and on a predetermined policy, and if there is the abnormal status, the change of resource distribution to the VM, the preservation of the VM, the deletion of the VM, or the transfer of the VM to a sprawl VM collecting server is performed.

### CITATION LIST

### Patent Literature

Patent Literature 1: Japanese Patent Application Publication No. 2012-216008

### SUMMARY OF INVENTION

### Technical Problem

In the technology disclosed by Patent Literature 1, a possibility that a necessary VM is deleted if VMs are deleted on the basis of the observation of the usage statuses of resources is not taken into consideration. For example, in the case where a standby system is comprised of an in-current-use VM and a standby VM, there is a possibility that the standby VM whose usage rate of resources is small is deleted.

### Solution to Problem

A VM management system to be disclosed includes: a VM operating status obtaining unit that obtains the usage status of resources used by a VM; a VM communication status obtaining unit that obtains the communication status between the VM and another VM; and a sprawl handling unit that deletes the VM and recovers the resources allocated to the VM if the operating status of the VM and the communication status do not satisfy the respective prescribed standards. The usage status of resources to be obtained at least includes the CPU usage rate.

### Advantageous Effects of Invention

According to the VM management system to be disclosed, a VM that must not be deleted can be prevented from being deleted.

### BRIEF DESCRIPTION OF DRAWINGS

FIG. 1 A configuration example of a VM system.

FIG. 2 An example of a VM operating status table.

FIG. 3 An example of a VM configuration information table.

FIG. 4 An example of a VM communication status table.

FIG. 5 The processing flowchart of a VM operating status obtaining unit.

FIG. 6 The processing flowchart of a VM communication status obtaining unit.

FIG. 7 The processing flowchart of a sprawl handling unit.

### DESCRIPTION OF EMBODIMENTS

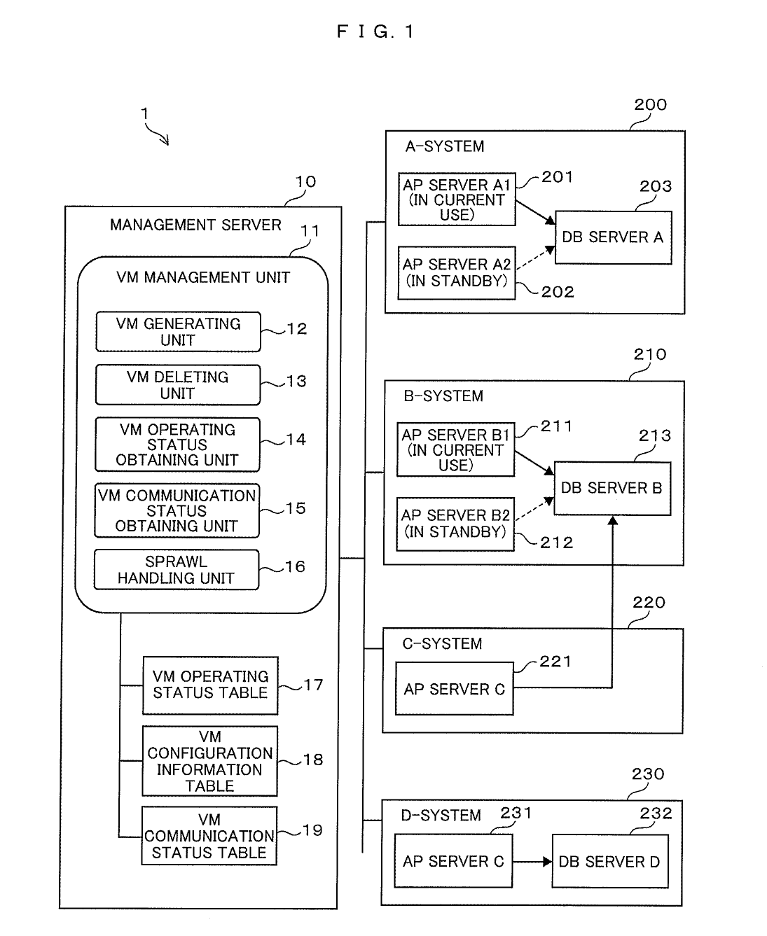

FIG. 1 shows a configuration example of a virtual machine system 1 (referred to as the VM system 1 hereinafter). The VM system 1 is virtually developed on one hardware computer or on plural hardware computers. The VM system 1 shown in FIG. 1 includes an A-system 200, a B-system 210, a C-system 220, and a D-system 230 as application systems that are comprised of AP servers and DB servers realized by virtual machines (VMs); and a management server 10 that manages the VMs of which the respective application systems are comprised.

The respective application systems will be concretely explained below. The A-system 200 is a system in which a standby (in-standby and backup) system is comprised of in-current-use AP server A1 (201) and in-standby AP server A2 (202), and that accesses databases via DB server A 203. The B-system 210 is similar to the A-system 200 and it is a system in which a standby (in-standby and backup) system is comprised of an in-current-use AP server B1 (211) and an in-standby AP server B2 (212), and that accesses databases via a DB server B 213. C-system 220 is a system in which an AP server C (221) accesses databases via the DB server B 213 of the B-system 210. The D-system 230 is a system in which an AP server D (231) accesses databases via a DB server D 232.

Here, it will be assumed that each of AP servers and DB servers of these application systems is developed on one independent VM for ease of explanation. In fact, plural servers are developed on one VM in some cases.

The management server 10 is developed on an independent hardware computer or on one VM, and includes a VM management unit 11 and tables used by the VM management unit 11. The VM management unit 11 includes: a VM generating unit 12; a VM deleting unit 13; a VM operating status obtaining unit 14; a VM communication status obtaining unit 15; and a sprawl handling unit 16. The VM generating unit 12 generates a VM, and allocates necessary resources (such as a logical CPU and a logical memory) to the generated VM in response to the request of VM generation. The VM deleting unit 13 recovers resources allocated to a VM to be deleted from the VM, and deletes the VM in response to the request of VM deletion. Detailed descriptions about the VM generating unit 12 and the VM deleting unit 13 will be omitted.

The VM operating status obtaining unit 14 obtains the usage statuses of resources used by VMs which realize AP servers and DB servers of which applications are comprised. The usage status of resources to be obtained at least includes the CPU usage rate. This is because, in order to recover computer resources that are not effectively used by VMs that have already finished their activities, the VM operating status obtaining unit 14 can obtain the operating statuses of the VMs by grasping the usage rates of CPUs allocated to the respective VMs. The CPU usage rates are the usage rates of logical CPUs allocated to the VMs, and they are obtained in %.

The VM communication status obtaining unit 15 obtains the communication statuses of VMs which realize AP servers and DB servers of which applications are comprised. The communication status of a VM is the status of the communication between the VM and another VM or another system (not limited to a VM system). The communication status is a communication amount during a prescribed time period, and it is obtained by the Mbps. The communication between the VM and another VM includes the communication of transmission and the communication of reception, and there is a large difference between the communication amount of transmission and that of the reception during a prescribed time period in some cases. For example, such a case is a case where a download (reception) is executed in response to the request of an image file (transmission). Therefore, the sum of the communication amounts of transmission and reception is used as the communication status between the VM and another VM. The communication between the VM and another VM includes a heart beat signal transmitted between AP servers (between VMs) of which the above-mentioned standby system is comprised. A packet or a special signal is used as the heart beat signal, and whether the heart beat signal is the packet or the special signal, the heart beat signal can be measured as a communication amount (information amount) during a prescribed time period.

The usage status of resources used by a VM and the communication status of the VM is generally stored in a prescribed memory area by a monitoring program included in an OS running on the VM. If there is not such a monitoring program, an agent program that measures the usage status of resources and the communication status has only to be installed in each VM.

The measurement values of the usage status of resources (CPU usage rate) and the communication status (a communication amount during a prescribed time period) vary with time. In many cases, these measurement values stored in a prescribed memory area by a monitoring program or an agent program are instantaneous values. Therefore, average values or maximum values during a prescribed time period such as one minute or five minutes are used as measurement values. To put it briefly, it is all right if it can be judged whether a VM is operating or not. Viewed in this light, it is inconvenient to use the minimum value of measurement values having a large fluctuation band.

The sprawl handling unit 16 judges whether a VM can be deleted or not on the basis of the operating status and the communication status of the VM (when prescribed standards are not satisfied), and if the VM can be deleted, the sprawl handling unit 16 activates the VM deleting unit 13, allows the VM deleting unit 13 to delete the VM that is a target of deletion, and recovers resources allocated to the VM. The prescribed standard about the operating status is an after-mentioned CPU usage rate threshold of the VM and the prescribed standard about the communication status is an after-mentioned communication amount threshold of the VM. The sprawl handling unit 16 updates an after-mentioned VM configuration information table 18 in accordance with the deletion of the VM.

Tables used by the VM management unit 11 are a VM operating status table 17, a VM configuration information table 18, and a VM communication status table 19.

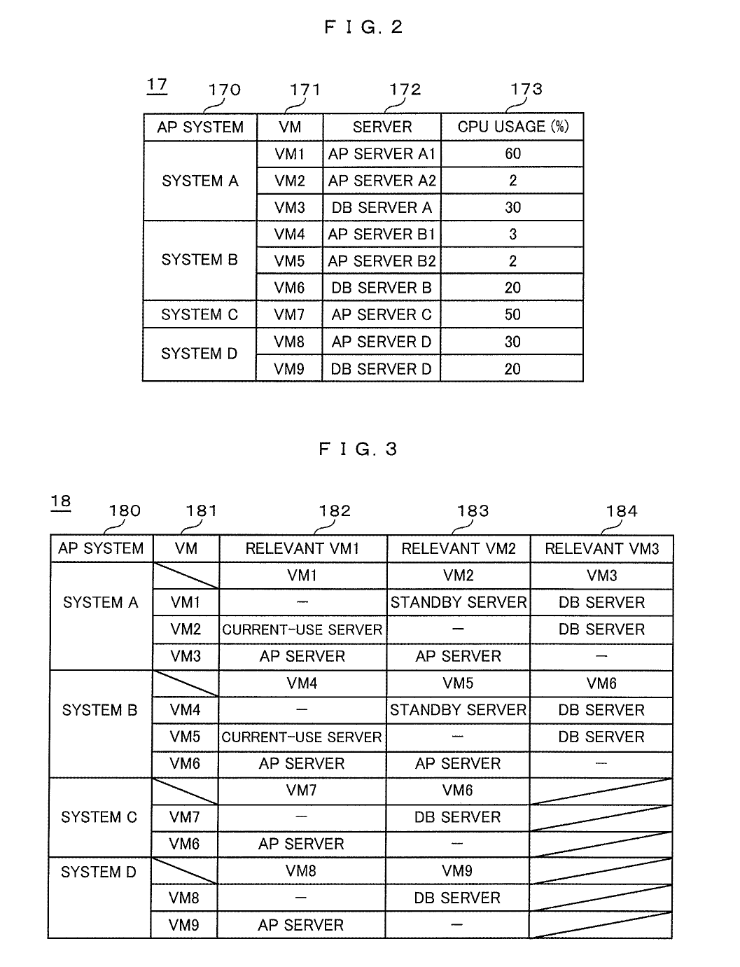

The VM operating status table 17 is a table in which the operating statuses (CPU usage rates) of VMs are stored for the respective VMs. FIG. 2 is a diagram showing an example of the VM operating status table 17 corresponding to the configuration of the VM system 1. The VM operating status table 17 includes: an AP system 170; a VM 171 of which the AP system 170 is comprised; a server 172 that is developed by the VM 171; and a CPU usage rate 173 of the VM 171. The AP system 170 is configured as an AP system 170 comprised of the VM 171 with reference to an after-mentioned VM configuration information table 18. Examples of numerical data shown in FIG. 2 will be described later.

The VM configuration information table is a table in which relations among VMs of which the respective application systems are comprised are shown. While VMs are sequentially generated in accordance with the configuration specifications of the application systems, the VM configuration information table 18 is generated in advance in accordance with the configuration specifications of the application systems, and is updated by the sprawl handling unit 16 (an already-deleted VM is deleted from the VM configuration information table 18). It is conceivable that the VM deleting unit 13 updates the VM configuration information table 18 in accordance with the deletion of a VM. However, in this case, in order to point out the update of the VM configuration information table 18 explicitly, it will be assumed that the update is executed by the sprawl handling unit 16. FIG. 3 is a diagram showing an example of the VM configuration information table 18 corresponding to the configuration of the VM system 1 shown in FIG. 1.

The VM configuration information table 18 shows relations among VM 181 of which AP system 180 is comprised, and relevant VMs 182, 183, and 183 to each of which VM 181 is relevant. For example, VM1 of system A as AP system 180 is a VM showing that VM2 is a standby server of VM1 as its relevant VM, and that VM3 is a VM as its DB server. Therefore, the update of the VM configuration information table 18 by the sprawl handling unit 16 is done in such a way that row data including the deleted VM181 and column data including the deleted VM181 as a relevant VM are deleted.

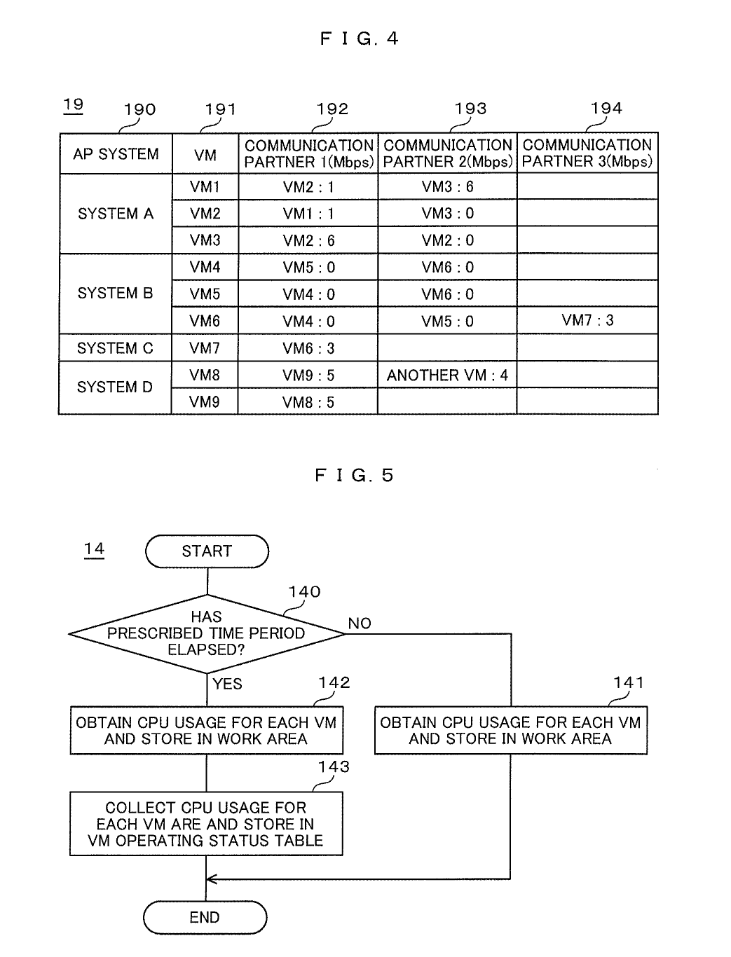

The VM communication status table 19 is a table that stores the communication status of each VM, which are obtained by the VM communication status obtaining unit 15, for each communication partner. FIG. 4 is a diagram showing an example of the VM communication status table 19 corresponding to the configuration of the VM system 1. The VM communication status table 19 stores an AP system 190, a VM 191 of which the AP system 190 is comprised, communication amounts classified by the respective communication partners 192, 193, and 194 with whom the VM 191 communicate. The AP system 190 is configured as an AP system 190 comprised of the VM 191 with reference to the abovementioned VM configuration information table 18. Communication partners of VMs included in the VM system 1 are not always included in the VM system 1. VM8 shown in FIG. 4 is an example of a VM that has a server (for example, a Web server) included in another system (this system is not always a VM system) that is different from the VM system 1 as its communication partner. Examples of numerical data shown in FIG. 4 will be described later.

FIG. 5 shows the processing flowchart of the VM operating status obtaining unit 14. The VM operating status obtaining unit 14 is activated by a periodic timer with a prescribed time period. It will be assumed that a prescribed time interval at which a CPU usage rate for each VM 171 is written into is 10 minutes and an activation cycle for the VM operating status obtaining unit 14 is 1 minute. After the VM operating status obtaining unit 14 is activated, the VM operating status obtaining unit 14 judges whether or not the prescribed time period for writing CPU usage rate 173 into the VM operating status table has elapsed (S140). It is conceivable that the judgment whether the prescribed time period has elapsed or not is done by counting the number of the VM operating status obtaining unit 14 being activated, and if the prescribed time period (10 minutes) has elapsed (the counter has counted 10), the counter is reset. If the prescribed time period has not elapsed yet, the VM operating status obtaining unit 14 obtains a CPU usage rate for each VM included in the VM system 1, and stores the CPU usage rate in a work area (S141), and finishes this processing.

If the prescribed time period has elapsed, the VM operating status obtaining unit 14 obtains a CPU usage rate for each VM, and stores the CPU usage rate in the work area (S142), and therefore CPU usage rates for 10 activation cycles for each VM are stored in the work area. The VM operating status obtaining unit 14 collects the CPU usage rates stored in the work area for each VM 171, and stores the collected data in the VM operating status table 17 as CPU usage rate 173 (S143), and finishes this processing. The collection of the CPU usage rates is work in which the average value or the maximum value of the CPU usage rates for 10 activation cycles, which are stored in the work area as mentioned above, is calculated.

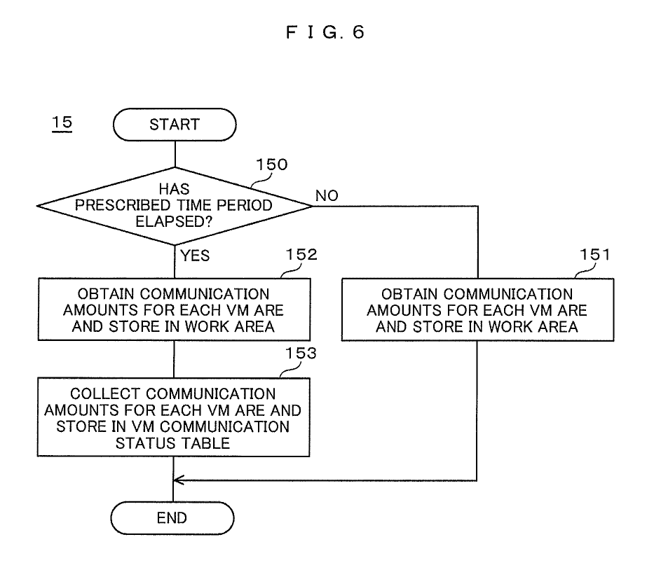

FIG. 6 shows the processing flowchart of the VM communication status obtaining unit 15. In the processing flow of the VM communication status obtaining unit 15, a periodic timer and a prescribed time interval are the same as those in the processing flow of the VM operating status obtaining unit 14, therefore the detailed descriptions about the periodic timer and the prescribed time interval will be omitted. On being activated, the VM communication status obtaining unit 15 judges whether a prescribed time period for writing a communication amount 192, 193, or 194 into the VM communication status table 19 for each communication partner for each VM 191 has elapsed or not (S150). If the prescribed time period has not elapsed, the VM communication status obtaining unit 15 obtains a communication amount for each VM included in the VM system 1, stores the communication amount in a work area (S151), and finishes this processing. If the obtained communication amount is measured by the byte or by the bit, the communication amount is changed to the amount measured by the Mbps and stored in the work area. In addition, in the case where the VM uses plural communication ports, the sum of communication amounts that are transmitted through the plural communication ports is used as the communication amount of the VM.

If the prescribed time period has elapsed, the VM communication status obtaining unit 15 obtains the communication amount for each VM, and stores the communication amount in the work area (S152), and then the communication amounts for 10 activation cycles for each VM are stored in the work area. The VM communication status obtaining unit 15 collects communication amounts stored in the work area for each communication partner of each VM 191, and stores the collected data in the VM communication status table 19 as communication amounts 192, 193, and 194 (S153), and finishes this processing. The collection of the communication amounts is work in which the average value or the maximum value of the communication amounts for 10 activation cycles, which are stored in the work area as mentioned above, is calculated.

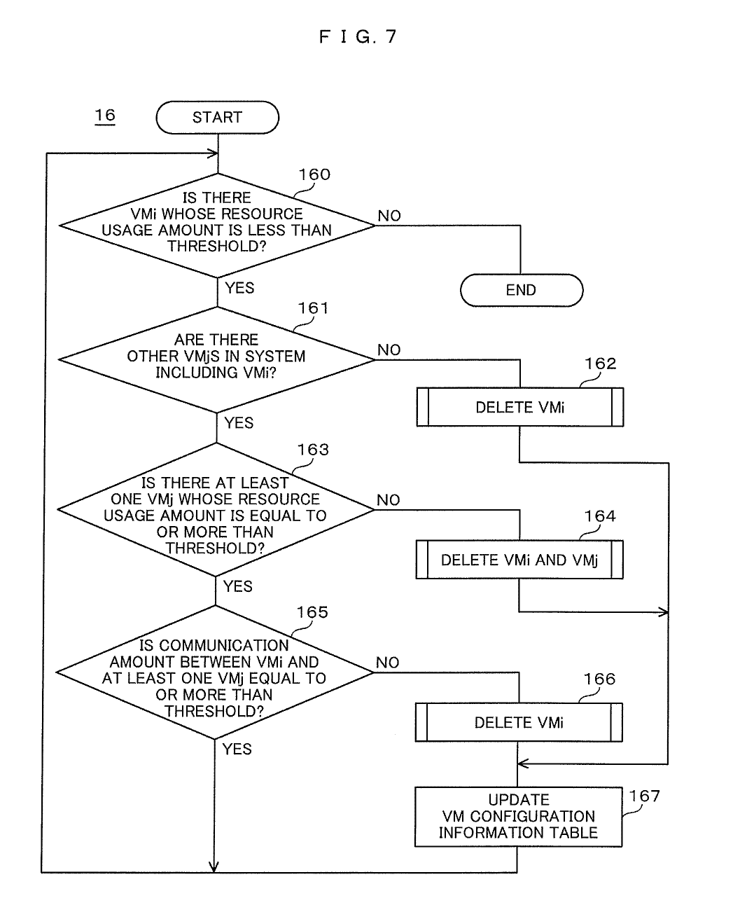

FIG. 7 shows the processing flowchart of the sprawl handling unit 16. The sprawl handling unit 16 is activated by a periodic timer with a prescribed time period. Here, the prescribed time period is 10 minutes as is the case with the above-mentioned examples. After the sprawl handling unit 16 is activated, the sprawl handling unit 16 judges whether there is a VM, which is stored in the VM operating status table 17 and whose resource usage amount (CPU usage rate 173) is less than a threshold or not (S160), and if there is no VM whose resource usage amount less than the threshold, this processing is finished. It will be assumed that the CPU usage rate threshold is 5% in this case. The CPU usage rate threshold can be set variable by installing a user interface for changing the threshold in the management server 10, or the CPU usage rate threshold can be set for each AP system 190.

It is assumed here that a VM whose resource usage amount is less than the threshold is denoted by a VMi, and it is judged whether there is a VMj other than the VMi in AP system 190 including the VMi or not (S161). If there is no VMj, because it can be said that AP system 190 includes only the VMi, VMi is deleted after the VM deleting unit 13 is activated (S162), and the VM configuration information table 18 is updated (S167). described above, the update of the VM configuration information table 18 is done in such a way that row data including the deleted VMi and column data including the deleted VMi as a relevant VM are deleted.

If there is a VMj in AP system 190 including the VMi, it is judged whether or not the resource usage amount (CPU usage rate 173) of the VMj is equal to or more than the threshold with reference to the VM operating status table 17 (S163). In this case, there is a case where there are plural VMjs in the AP system 190 including the VMi. In the case where there are plural VMjs, it is judged whether or not the resource usage amount of at least one VMj is equal to or more than the threshold. If the resource usage amounts of all the VMjs are less than the threshold, because the activity of AP system 190 including the VMi and these VMjs has been finished, the VM deleting unit 13 is activated, the VMi and these VMjs included in the AP system are deleted (S164), and the VM configuration information table 18 is updated regarding the VMi and these VMjs (S167).

In the case where the resource usage amount (CPU usage rate 173) of the at least one VMj is equal to or more than the threshold, it is judged whether the communication amount between the VMi and the VMj is equal to or more than a threshold or not (S165). There is a case where there are plural VMjs. In this case, it is judged whether or not the resource usage amount of at least one VMj is equal to or more than the threshold. Here, it will be assumed that the communication amount threshold is 1 Mbps. Descriptions about the setting of the communication amount threshold are similar to those mentioned above about the setting of the CPU usage rate threshold. If the communication amount between the VMi and the VMj is less than the communication amount threshold, because CPU usage rate 173 of the VMi is less than the CPU usage rate threshold, and the communication amount is also less than the communication amount threshold, the VM deleting unit 13 is activated and the VMj is deleted (S166), the VM configuration information table 18 is updated (S167), and the flow goes back to step S160.

If the communication amount between the VMi and the VMj is equal to or more than the threshold, the flow goes back to step S160 as is the case with the flow after the update of the VM configuration information table 18. Even in this case, that is, in the case where the CPU usage rate of the VMi is less than the CPU usage rate threshold, the VMi is preserved (that is, not deleted and kept alive) because the communication amount is equal to or more than the communication amount threshold.

In the case where there is a VMi whose CPU usage rate is less than the threshold, and the processes prescribed from steps S161 are performed on this VMi, it means that the processes about only this VMi, whose CPU usage rate is less than the threshold, is finished. Therefore, processes after the flow goes back to step S160 are set to be performed on another VMi whose CPU usage rate is less than the threshold and on which the processes have not been performed yet. Although a detailed description about this point will be omitted, this point will be clarified by an after-mentioned explanation with examples of numerical data.

With reference to FIG. 2 to FIG. 4, the processing of the sprawl handling unit 16 shown in FIG. 7 will be described again. After the sprawl handling unit 16 is activated, the sprawl handling unit 16 judges whether or not there is a VM that is stored in the VM operating status table 17 and whose resource usage amount (CPU usage rate 173) is less than the threshold (5%) (S160), and as a result VM2 that is included in a system-A and whose CPU usage rate is 2% is found as a VMi. VM1 and VM3 are found in the system-A that includes VM2 as VMjs (S161). As a result of VM1 and VM3 being found, it is judged whether the resource usage amount of VM1 or that of VM3 (the resource usage amount of VM1 is 60%, and that of VM3 is 30%) is equal to or more than the threshold (5%) or not with reference to the VM operating status table 17 (S163), and because both resource usage amounts are equal to or more than the threshold, it is judged whether the communication amount between VM2 and VM1 or that between VM2 and VM3 (the communication amount between VM2 and VM1 is 1 Mbps and that between VM2 and VM3 is 0 Mbps) is equal to or more than the threshold (1 Mbps) or not (S165). In the case where there are plural VMjs, it is judged whether the communication amount of at least one VMj is equal to or more than the threshold or not, and it is judged that the communication amount between VM2 and VM1 1 Mbps is equal to or more than the threshold (1 Mbps). In other words, although CPU usage rate 173 of VM2 is less than the threshold (5%), because the communication amount 1 Mbps between VM2 and VM1 is equal to or more than the threshold (1 Mbps), the sprawl handling unit 16 does not regard VM2 as a target of deletion considering VM2 as a standby server of VM1.

The flow goes back to step S160, and because there is no VM whose resource usage amount is less than the threshold other than VM2 that have been dealt with as a processing target, the processing is performed on VMs included in other AP systems such as a system-B and others. When it is examined whether there is a VM that is stored in the VM operating status table 17 and whose resource usage amount (CPU usage rate 173) is less than the threshold (5%) or not (S160), VM4 that is included in the system-B and whose resource usage amount (CPU usage rate 173) is 0% is found. As VMjs, VM5 and VM6 are found in the system-B that includes VM4 (S161). When it is judged whether or not the resource usage amount of VM5 or that of VM6 (the resource usage amount of VM5 is 0%, and that of VM6 is 20%)(S163) is equal to or more than the threshold (5%) (S163), because the resource usage amount (CPU usage rate 173) of VM6 is equal to or more than the threshold (5%), it is judged whether or not the communication amount between VM4 as a VMj and VM6 as a VMj (0 Mbps) is equal to or more than the threshold (1 Mbps) (S165). Because the communication amount between VM4 and VM6 (0 Mbps) is less than the threshold (1 Mbps), the VM deleting unit 13 is activated, VM4 as a VMj is deleted (S166), the VM configuration information table 18 is updated (S167), and the flow goes back to step S160. In this case, as described above, the update of the VM configuration information table 18 is done in such a way that row data including VM4 and column data including VM4 as a relevant VM are deleted.

When the flow goes back to step S160 and it is judged whether there is a VM whose resource usage amount (CPU usage rate 173) is less than the threshold (5%) or not (S160), VM5 that is included in the system-B and whose resource usage amount (CPU usage rate 173) is 0% is found. Because the processing of this VM5 being treated as a VMi is almost the same as the processing of VM4, the explanation of the processing of this VM5 will be omitted. As a result, VM5 is deleted, and VM6 is left as it is.

When the flow goes back to step S160 again, there is no VM whose resource amount (CPU usage rate 173) is less than the threshold (5%) and that has not been processed yet (S160), and therefore the sprawl handling unit 16 finishes its processing. However, according to the above explanation of the examples of numerical data, because VM6 included in the system-B in the VM configuration information table 18 has no relevant VM, the sprawl handling unit 16 deletes row data including VM6 before the sprawl handling unit 16 finishes its processing. However, there is a case where VM6 included in a system-C is not set as a row in VM 181 depending on the design of the VM configuration information table 18 shown in FIG. 3. In this case, VM6 included in the system-C is set as a row in VM 181, and after a relevant VM is set, row data including VM6 included in the system-B is deleted.

Next, supplementary explanations about the activations of the VM operating status obtaining unit 14, the VM communication status obtaining unit 15, and the sprawl handling unit 16 will be made. It has been described so far that the VM operating status obtaining unit 14 and the VM communication status obtaining unit 15 are activated by a periodic timer with a 1-minute time period, and the sprawl handling unit 16 is activated by a periodic timer with a 10-minute time period. In this case, it is conceivable that the VM operating status obtaining unit 14 is activated by a periodic timer with a 1-minute time period, the VM communication status obtaining unit 15 is activated by the VM operating status obtaining unit 14 once every minute when the VM operating status obtaining unit 14 finishes its process, and the VM communication status obtaining unit 15 activates the sprawl handling unit 16 in synchronization with a timing when a communication amount collected by the VM communication status obtaining unit 15 is stored in the VM communication status table 19.

On the other hand, particularly when the sprawl handling unit 16 is activated periodically, the load of the management server 10 in association with the execution of the sprawl handling unit 16 becomes heavy. As another problem, a problem in association with the occurrence of the sprawl of VMs is the fact that, because VMs that have already finished their activities do not release resources allocated to them, the number of resources to be allocated to new VMs becomes insufficient. Although a description about the management of resources allocated to VMs has been omitted so far, the management of the resources can be done in such a way that the management server 10 detects a state in which resources to be allocated to new VMs are running short, and activates the sprawl handling unit 16 in accordance with this detection, with the result that the load of the management server 10 in association with the execution of the sprawl handling unit 16 can be lessened. The state in which resources are running short can be known by detecting whether resources of the VM system 1 have been allocated with a rate equal to or more than a prescribed rate (conversely, by detecting whether resources have not been allocated yet with a rate equal to or less than the prescribed rate).

According to this embodiment, for example, in the case where a standby system is comprised of an in-current-use VM and a standby VM, the standby VM whose usage rate of resources are small can be prevented from being deleted.

### LIST OF REFERENCE SIGNS

1: VM System, 10: Management Server, 11: VM Management Unit, 12: VM Generating Unit, 13: VM Deleting Unit, 14: VM Operating Status Obtaining Unit, 15: VM Communication Status Obtaining Unit, 16: Sprawl Handling Unit, 17: VM Operating Status Table, 18: VM Configuration Information Table, 19: VM Communication Status Table, 200 to 230: Application Systems

1. A VM management system comprising:
a VM operating status obtaining unit that obtains the usage status of resources used by a VM;
a VM communication status obtaining unit that obtains the communication status between the VM and another VM; and
a sprawl handling unit that deletes the VM and recovers the resources allocated to the VM if the operating status of the VM does not satisfy a first prescribed standard and the communication status does not satisfy a second prescribed standard.

2. The VM management system according to claim 1, wherein the sprawl handling unit preserves the VM if the operating status of the VM does not satisfy the first prescribed standard and the communication status satisfies the second prescribed standard.

3. The VM management system according to claim 2, wherein the usage status of the resources used by the VM is at least the usage rate of a logical CPU allocated to the VM.

4. The VM management system according to claim 2, wherein the communication status between the VM and another VM is the sum of the communication amounts of transmission and reception performed by the VM during a prescribed time period.

5. The VM management system according to claim 4, wherein the communication for obtaining the communication status includes a heart beat signal transmitted between the VM and another VM of which a standby system is comprised.

6. A management method for a virtual machine (VM) management system for managing a VM, wherein the VM management system:
obtains the usage rate of resources used by the VM;
obtains the communication status between the VM and another VM; and
deletes the VM and recovers resources allocated to the VM if the operating status of the VM does not satisfy a first prescribed standard and the communication status does not satisfy a second prescribed standard.

7. The VM management method according to claim 6, wherein the VM management system preserves the VM if the operating status of the VM does not satisfy the first prescribed standard and the communication status satisfies the second prescribed standard.

8. The VM management method according to claim 7, wherein the usage status of the resources used by the VM is at least the usage rate of a logical CPU allocated to the VM.

9. The VM management method according to claim 7, wherein the communication status between the VM and another VM is the sum of the communication amounts of transmission and reception performed by the VM during a prescribed time period.

10. The VM management method according to claim 9, wherein the communication for obtaining the communication status includes a heart beat signal transmitted between the VM and another VM of which a standby system is comprised.
